(19) United States
(12) Patent Application Publication
(10) Pub. No.: US 2026/0201882 A1
(43) Pub. Date: Jul. 16, 2026

(54) SCROLL COMPRESSOR

(71) Applicant: Hanon Systems, Daejeon (KR)

(72) Inventors: Kweon Soo Lim, Daejeon (KR); In Cheol Shin, Daejeon (KR)

(21) Appl. No.: 19/138,433

(22) PCT Filed: Feb. 16, 2024
(86) PCT No.: PCT/KR2024/095360

§ 371 Date: Jun. 12, 2025

(30) Foreign Application Priority Data
May 16, 2023 (KR) 10-2023-0063127

(51) Int. Cl. F04C 18/02; F04C 29/06

(52) U.S. Cl. CPC F04C 18/0215; F04C 29/06

(57) ABSTRACT

A scroll compressor, including: a drive shaft provided to be rotatable by a drive source; an orbiting scroll including a disc-shaped orbiting base plate and an orbiting wrap protruding from the orbiting base plate and configured to be orbited by the drive shaft; and a fixed scroll including a fixed base plate opposing to the orbiting base plate, a fixed wrap protruding from the fixed base plate and engaged with the orbiting wrap, and a fixed wrap extension protruding from the fixed base plate at a position radially spaced apart from the fixed wrap, and according to the scroll compressor, the turn-over of the orbiting scroll can be suppressed.

### CROSS REFERENCE TO RELATED PATENT APPLICATIONS

This is a U.S. national phase patent application of PCT/KR 2024/095360 filed Feb. 16, 2024, which claims the benefit of and priority to Korean Patent Application No. 10-2023-0063127, filed on May 16, 2023, the entire contents of each of which are incorporated herein by reference for all purposes.

### TECHNICAL FIELD

The present disclosure relates to a scroll compressor, more particularly, to a scroll compressor configured to compress a refrigerant using a fixed scroll and an orbiting scroll.

### BACKGROUND ART

In general, an air-conditioning apparatus (A/C) for heating/cooling an interior space is installed in a vehicle. Such an air-conditioning apparatus is a component of a cooling system, and includes a compressor configured to compress a low-temperature and low-pressure gaseous refrigerant introduced from an evaporator to be converted into a high-temperature and high-pressure gaseous refrigerant and to provide the refrigerant to a condenser.

The compressor is classified into a reciprocating compressor that compresses a refrigerant according to which pistons reciprocate, and a rotary compressor that compresses a refrigerant while rotating. The reciprocating compressor includes a crank compressor that transmits a driving force from a drive source to a plurality of pistons using a crank, a swash plate compressor that transmits a driving force to a shaft installed with a swash plate, and the like, according to the power transmission from the drive source. The rotary compressor includes a vane rotary compressor that utilizes a rotating rotary shaft and a vane, and a scroll compressor that utilizes an orbiting scroll and a fixed scroll.

A scroll compressor is widely used for refrigerant compression in an air-conditioning apparatus, for example, as it is capable of obtaining a relatively higher compression ratio than other types of compressors, and acquiring a stable torque resulting from smooth strokes of suction, compression, and discharge of the refrigerant.

FIG. 1 is a cross-sectional view illustrating a conventional scroll compressor, and FIG. 2 is a cross-sectional view taken along I-I line in FIG. 1.

Referring to FIGS. 1 and 2, the conventional scroll compressor includes a drive source 20 configured to generate a rotational force, a drive shaft 30 configured to be rotated by the drive source 20, an orbiting scroll 50 configured to orbit by the drive shaft 30, and a fixed scroll 60 forming a compression chamber with the orbiting scroll 50.

However, the conventional scroll compressor has a problem in that the orbiting scroll 50 is turned over.

### SUMMARY

Therefore, the present disclosure aims to provide a scroll compressor capable of suppressing the turning-over of the orbiting scroll.

One embodiment is a scroll compressor, including: a drive shaft provided to be rotatable by a drive source; an orbiting scroll including a disc-shaped orbiting base plate and an orbiting wrap protruding from the orbiting base plate and configured to be orbited by the drive shaft; and a fixed scroll including a fixed base plate opposing to the orbiting base plate, a fixed wrap protruding from the fixed base plate and engaged with the orbiting wrap, and a fixed wrap extension protruding from the fixed base plate at a position radially spaced apart from the fixed wrap.

The orbiting wrap may include an orbiting wrap entrance end disposed on an outer circumferential portion of the orbiting base plate, and the fixed wrap may include a fixed wrap extension opposing to the orbiting wrap entrance end.

The fixed wrap may further include a fixed wrap entrance end disposed on an outer circumferential portion of the fixed base plate, a fixed wrap exit end disposed at a center of the fixed base plate, and a fixed wrap spiral extending in a spiral shape from the fixed wrap entrance end to the fixed wrap exit end, and the fixed wrap extension may be disposed at a position extended along the spiral shape from the fixed wrap entrance end to an opposite side of the fixed wrap spiral.

An inner circumferential surface of the fixed wrap extension may be formed to be contactable with an outer circumferential surface of the orbiting wrap entrance end.

An outer circumferential surface of the fixed wrap extension may be formed to have greater roughness than roughness of an inner circumferential surface of the fixed wrap extension.

A distal end surface of the fixed wrap extension may be formed to be contactable with the orbiting base plate.

The outer circumferential portion of the orbiting base plate may include a first outer circumferential portion disposed on a side of the orbiting wrap entrance end, and a second outer circumferential portion disposed on an opposite side of the first outer circumferential portion based on a center of the orbiting base plate, and the first outer circumferential portion may be contactable with the fixed wrap extension, and the second outer circumferential portion may be contactable with at least one among the fixed wrap entrance end and the fixed wrap spiral.

A suction inlet may be formed between the fixed wrap entrance end and the fixed wrap extension.

The fixed wrap entrance end and the fixed wrap extension may be segmented from each other by the suction inlet.

The fixed wrap extension may extend along the spiral shape to the suction inlet.

The fixed scroll may further include a fixed side wall protruding from the outer circumferential portion of the fixed base plate, and the fixed wrap extension may include a contacting portion in contact with the fixed side wall and a non-contacting portion spaced apart from the fixed side wall.

The fixed side wall may include a recessed portion formed to be recessed on an inner circumferential surface of the fixed side wall at a position opposing to the non-contacting portion.

The fixed wrap extension may include at least one among a through hole penetrating the fixed wrap extension and a slit formed to be recessed from the distal end surface of the fixed wrap extension.

The through hole and the slit may be formed in the non-contacting portion.

A suction inlet may be formed between the fixed wrap entrance end and the fixed wrap extension, and the suction inlet may be formed to be greater than the through hole and the slit.

The scroll compressor according to the present disclosure includes: a drive shaft provided to be rotatable by a drive source; an orbiting scroll including a disc-shaped orbiting base plate and an orbiting wrap protruding from the orbiting base plate, and configured to be orbited by the drive shaft; and a fixed scroll including a fixed base plate opposing to the orbiting base plate, a fixed wrap protruding from the fixed base plate and engaged with the orbiting wrap, and a fixed wrap extension protruding from the fixed base plate at a position radially spaced apart from the fixed wrap, thereby becoming capable of suppressing the turning-over of the orbiting scroll.

Accordingly, a flow of the orbiting scroll in radial and axial directions is prevented, thereby preventing deterioration of damage and noise caused by a collision between the fixed scroll and the orbiting scroll, deterioration of compressing efficiency due to leakage in a compression chamber and a backpressure chamber, damage and deterioration of noise and vibration of a bearing, an eccentric bush, a drive shaft and the like.

### DESCRIPTION OF DRAWINGS

FIG. 1 is a cross-sectional view illustrating a conventional scroll compressor,

FIG. 2 is a cross-sectional view taken along I-I line in FIG. 1,

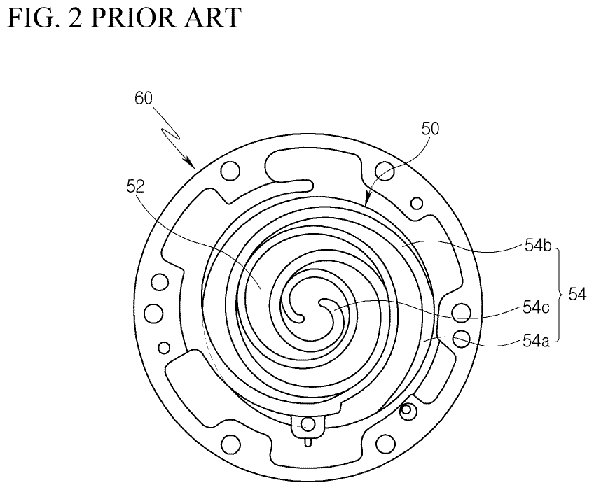

FIG. 3 is a cross-sectional view illustrating a fixed scroll and an orbiting scroll in a scroll compressor according to an embodiment of the present disclosure,

FIG. 4 is a cross-sectional view illustrating a state in which an orbiting scroll of FIG. 3 orbits,

FIG. 5 is a perspective view illustrating a fixed scroll of FIG. 3,

FIG. 6 is a perspective view illustrating a fixed scroll in a scroll compressor according to another embodiment of the present disclosure, and

FIG. 7 is a perspective view illustrating a fixed scroll in a scroll compressor according to still another embodiment of the present disclosure.

### DESCRIPTION OF AN EMBODIMENT

Hereinafter, a scroll compressor according to the present disclosure will be described in more detail with reference to the accompanying drawings.

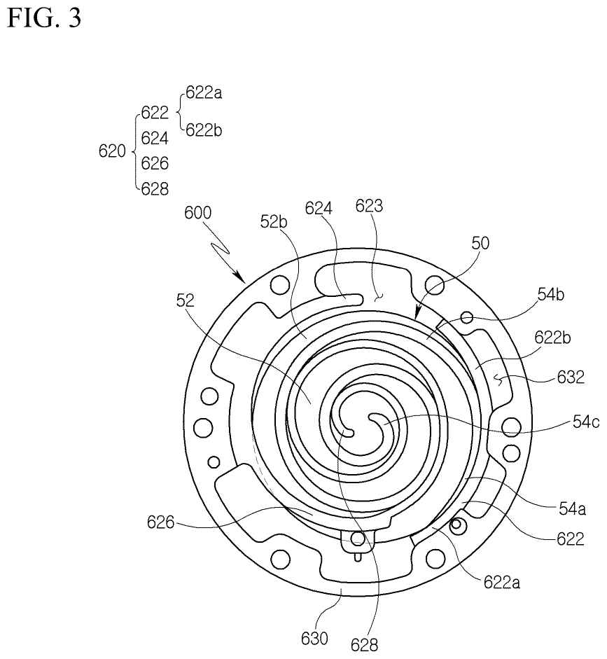

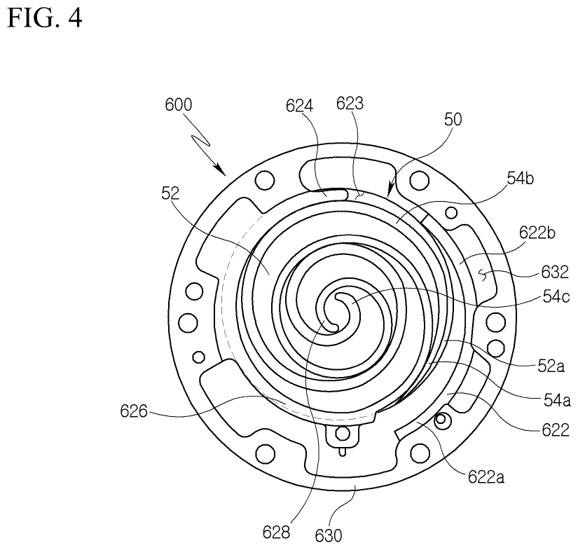

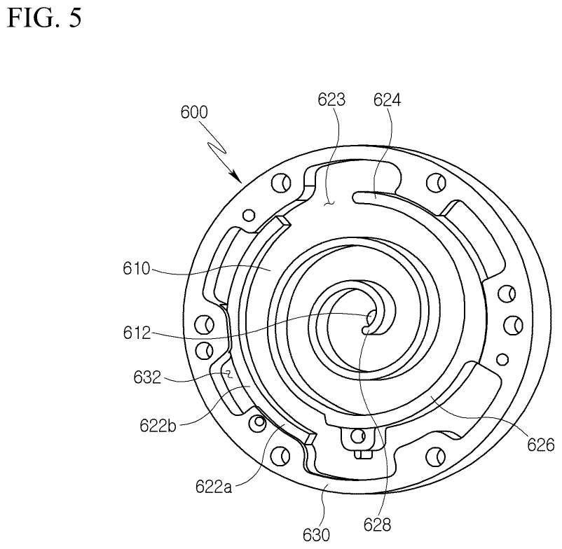

FIG. 3 is a cross-sectional view illustrating a fixed scroll and an orbiting scroll in a scroll compressor according to an embodiment of the present disclosure, FIG. 4 is a cross-sectional view illustrating a state in which an orbiting scroll of FIG. 3 orbits, and FIG. 5 is a perspective view illustrating a fixed scroll of FIG. 3.

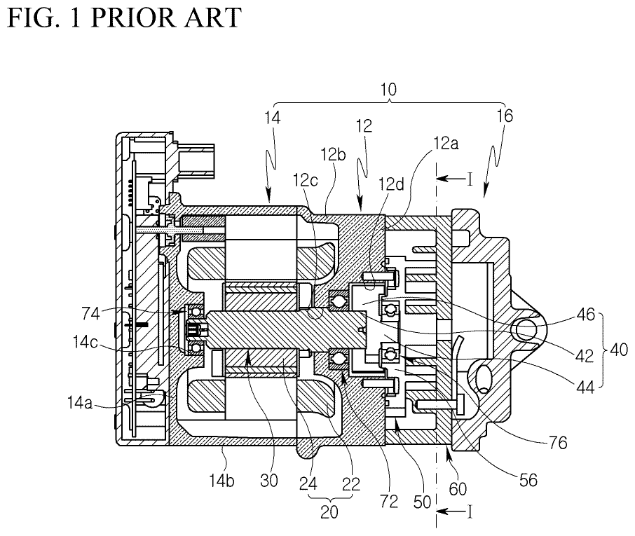

Meanwhile, components not illustrated in FIGS. 3 to 5 will be described by referring to FIG. 1 for convenience of description.

Referring to FIGS. 3 to 5 and FIG. 1, the scroll compressor according to an embodiment of the present disclosure may include a housing 10, a drive source 20 provided inside the housing 10 and configured to generate a rotational force, a drive shaft 30 receiving a rotational force from the drive source 20 and configured to be rotated; an eccentric bush 40 configured to convert a rotation of the drive shaft 30 into an eccentric rotation; an orbiting scroll 50 configured to be orbited by the eccentric bush 40; and a fixed scroll 600 engaged with the orbiting scroll 50 and forming a compression chamber with the orbiting scroll 50.

The housing 10 may include a center housing 12 fastened to one side of the fixed scroll 600; a front housing 14 coupled to the center housing 12 and forming a drive source accommodating space in which the drive source 20 is accommodated; and a rear housing 16 coupled to another side of the fixed scroll 600 and having a discharge chamber in which the refrigerant discharged from the compression chamber is accommodated.

The center housing 12 may include a center housing partition wall 12a partitioning the drive source accommodating space and the scroll accommodating space; and a center housing side wall 12b extending along an outer circumferential portion of the center housing partition wall 12a.

Here, the center housing partition wall 12a may include a bearing hole 12c into which one end of the drive shaft 30 is inserted; a backpressure chamber 12d accommodating a fluid for pressurizing the orbiting scroll 50 toward the fixed scroll 600 and providing a space in which the eccentric bush 40 can be rotated; and a communicating hole (not illustrated) communicating the drive shaft accommodating space with an orbiting scroll accommodating space to be described below.

The front housing 14 may include a front housing partition wall 14a opposing to the center housing partition wall 12a; and a front housing side wall 14b extending along an outer circumferential portion of the front housing partition wall 14a and fastened to the center housing side wall 12b, and the front housing partition wall 14a may include a bearing groove 14c into which another end of the drive shaft 30 is inserted, and the front housing side wall 14b may include a suction port (not illustrated) penetrating the front housing side wall 14b such that the refrigerant is guided to the drive source accommodating space.

The drive source 20 may be formed as a motor having a stator 22 and a rotor 24. However, the drive source 20 is not limited thereto, and may be formed as a disc hub assembly interworking with an engine of the vehicle.

The drive shaft 30 may be coupled to the rotor 24, and may penetrate the rotor 24 such that one end thereof is inserted into the bearing hole 12c and another end thereof is inserted into the bearing groove 14c.

Here, between an outer circumferential surface of the one end of the drive shaft 30 and an inner circumferential surface of the bearing hole 12c, a first bearing 72 which rotatably supports the drive shaft 30 with respect to the hearing groove 12c may be disposed.

Further, between an outer circumferential surface of the another end of the drive shaft 30 and an inner circumferential surface of the bearing groove 14c, a second bearing 74 which rotatably supports the drive shaft 30 with respect to the bearing groove 14c may be disposed.

The eccentric bush 40 may include a recessed portion 42 into which one end of the drive shaft 30 is inserted; an eccentric portion 44 protruding toward an opposite side of the drive shaft 30 based on the recessed portion 42 and being eccentric to the drive shaft 30; and a balance weight 46 disposed on an opposite side of the eccentric portion 44 based on the recessed portion 42 so as to create an overall balance of the eccentric bush 40.

Here, the drive shaft 30 and the eccentric bush 40 may be formed such that rotational play is generated between an inner circumferential surface of the recessed portion 42 and an outer circumferential surface of the drive shaft 30 so as to prevent damage of the scroll because of the compression of a liquid refrigerant during the initial driving, for example.

That is, the drive shaft 30 and the eccentric bush 40 may be swingably coupled to each other with respect to the drive shaft 30 based on a position at which the eccentric bush 40 is eccentric from a rotational axis of the drive shaft 30.

The orbiting scroll 50 may be disposed in the orbiting scroll accommodating space formed by the center housing 12 and the fixed scroll 600, and may include a disc-shaped orbiting base plate 52, an orbiting wrap 54 protruding from one surface of the orbiting base plate 52, and an annular-shaped boss portion 56 protruding from another surface of the orbiting base plate 52 and forming a groove into which the eccentric portion 44 is inserted.

Here, the orbiting wrap 54 may include an orbiting wrap entrance end 54a disposed on an outer circumferential portion of the orbiting base plate 52, an orbiting wrap exit end 54c disposed at a center of the orbiting base plate 52, and an orbiting wrap spiral 54b extending in a spiral shape from the orbiting wrap entrance end 54a to the orbiting wrap exit end 54c.

Meanwhile, between an outer circumferential surface of the eccentric portion 44 and an inner circumferential surface of the boss portion 56, a third bearing 76 which rotatably supports the eccentric portion 44 with respect to the boss portion 56 may be disposed.

The fixed scroll 600 may include a fixed base plate 610 opposed to the orbiting base plate 52, a fixed wrap 620 protruding from the fixed base plate 610 and engaged with the orbiting wrap 54, and a fixed side wall 630 annularly protruding from an outer circumferential portion of the fixed base plate 610; fastened to the center housing 12; and forming the orbiting scroll accommodating space.

Here, the fixed wrap 620 may include a fixed wrap entrance end 624 disposed on the outer circumferential portion of the fixed base plate 610, a fixed wrap exit end 628 disposed at a center of the fixed base plate 610, and a fixed wrap spiral 626 extending in a spiral shape from the fixed wrap entrance end 624 to the fixed wrap exit end 628.

In addition, the fixed wrap 620 may further include a fixed wrap extension 622 protruding from the fixed base plate 610 at a position radially spaced apart from the fixed wrap 620. That is, the fixed wrap 620 may further include the fixed wrap extension 622 disposed at a position extending along the spiral shape from the fixed wrap entrance end 624 to an opposite side of the fixed wrap spiral 626 and opposing to the orbiting wrap entrance end 54a.

The fixed wrap extension 622 may include a contacting portion 622a provided on a radial outside with respect to the center of the fixed scroll 600 and being in contact with the fixed side wall 630 so that a rotational radius of the orbiting scroll 52 can be secured to the fullest.

In addition, the fixed side wall 630 includes a recessed portion 632 formed to be recessed on the inner circumferential surface of the fixed side wall 630 so as to temporarily accommodate a refrigerant subjected to compression (the refrigerant discharged from the communicating hole (not illustrated)), and the fixed wrap extension 622 may further include a non-contacting portion 622b disposed at a position opposing to the recessed portion 632 and spaced apart from the fixed side wall 630.

In addition, a suction inlet 623 may be formed between the fixed wrap entrance end 624 and the fixed wrap extension 622 so as to guide the refrigerant in the recessed portion to the compression chamber, and a discharge port 612 may be formed on the fixed base plate 610 so as to discharge the refrigerant in the compression chamber.

Here, the fixed wrap extension 622 extends along the spiral shape in a manner of corresponding to the orbiting wrap 54, and when the fixed wrap extension 622 extends to the fixed wrap entrance end 624, the suction inlet 623 must be formed in a shape of a hole penetrating the fixed wrap 620. Therefore, in this case, a flow amount of the refrigerant introduced into the compression chamber may be limited because a size of the suction inlet 623 is limited in a height direction of the fixed wrap 620.

Considering the above, in the present embodiment, the fixed wrap extension 622 may extend along the spiral shape and may extend to the suction inlet 623 so that the size of the suction inlet 623 can be maximized in the height direction of the fixed wrap 620 in a manner that the suction inlet 623 is opened toward a distal end surface (a surface contacting one surface of the orbiting base plate 52) of the fixed wrap 620 and extends to the fixed base plate 610. That is, the fixed wrap extension 622 may be formed to be severed from the fixed wrap entrance end 624 by the suction inlet 623.

Here, in case of the fixed wrap extension 622, as will be described below, while the roughness of an inner circumferential surface of the fixed wrap extension 622 contactable with an outer circumferential surface of the orbiting wrap entrance end 54a is formed to be small, the roughness of an outer circumferential surface of the fixed wrap extension 622 not contactable with the orbiting wrap 54 may be formed to be greater than the roughness of the inner circumferential surface of the fixed wrap extension 622. Therefore, the manufacturing cost can be saved because a post process of the outer circumferential surface of the fixed wrap extension 622 is not needed.

Hereinafter, an operational effect of the scroll compressor according to the present embodiment will be described.

That is, when power is applied to the drive source 20, the drive shaft 30 may be rotated with the rotor 24 of the drive source 20, and the orbiting scroll 50 may be orbited through the eccentric bush 40. Therefore, through the suction port (not illustrated), a low-temperature and low-pressure refrigerant is introduced into the drive source accommodating space, the refrigerant in the drive source accommodating space is introduced into the orbiting scroll accommodating space through the communicating hole (not illustrated), the refrigerant introduced into the orbiting scroll accommodating space is introduced into the compression chamber through the suction inlet 623, is compressed to be converted into a high-temperature and high-pressure refrigerant, and then may be discharged to the outside of the housing 10 through the discharge port 612 and the discharge chamber.

Here, the scroll compressor according to the present embodiment includes the fixed wrap extension 622 opposing to the orbiting wrap entrance end 54a, and thus, may suppress the turning-over of the orbiting scroll 50.

In more detail, the outer circumferential portion of one surface of the orbiting base plate 52 includes a first outer circumferential portion 52a disposed on a side of the orbiting wrap entrance end 54a, and a second outer circumferential portion 52b disposed on an opposite side of the first outer circumferential portion 52a based on the center of the orbiting base plate 52, and the first outer circumferential portion 52a may be in contact with the fixed wrap extension 622, and the second outer circumferential portion 52b may be in contact with at least one among the fixed wrap entrance end 624 and the fixed wrap spiral 626. That is, when the orbiting scroll 50 is disposed as illustrated in FIG. 3, the first outer circumferential portion 52a may be in contact with a distal end surface of the fixed wrap extension 622. Moreover, when the orbiting scroll 50 is disposed as illustrated in FIG. 4, the second outer circumferential portion 52b may be in contact with at least one among a distal end surface of the fixed wrap entrance end 624 and a distal end surface of the fixed wrap spiral 626. As described above, according to the position of the orbiting scroll 50, the second outer circumferential portion 52b can be supported by the distal end surface of the fixed wrap entrance end 624 and the distal end surface of the fixed wrap spiral 626, and the first outer circumferential portion 52a may be supported by the distal end surface of the fixed wrap extension 622, thereby the turning-over of the orbiting scroll 50 can be suppressed.

Further, the outer circumferential surface of the orbiting wrap entrance end 54a may be in contact with the inner circumferential surface of the fixed wrap extension 622, and an outer circumferential surface of the orbiting wrap spiral 54b may be in contact with at least one among an inner circumferential surface of the fixed wrap entrance end 624 and an outer circumferential surface of the fixed wrap spiral 626. That is, when the orbiting scroll 50 is disposed as illustrated in FIG. 3, the outer circumferential surface of the orbiting wrap entrance end 54a may be in contact with the inner circumferential surface of the fixed wrap extension 622. In addition, when the orbiting scroll 50 is disposed as illustrated in FIG. 4, the outer circumferential surface of the orbiting wrap spiral 54b may be in contact with at least one among the inner circumferential surface of the fixed wrap entrance end 624 and an inner circumferential surface of the fixed wrap spiral 626. As such, according to the position of the orbiting scroll 50, the outer circumferential surface of the orbiting wrap spiral 54b may be supported by the inner circumferential surface of the fixed wrap entrance end 624 and the inner circumferential surface of the fixed wrap spiral 626, and the outer circumferential surface of the orbiting wrap entrance end 54a may be supported by the inner circumferential surface of the fixed wrap extension 622, thereby the turning-over of the orbiting scroll 50 can be further suppressed.

Because of this, a flow of the orbiting scroll 50 in radial and axial directions is prevented, thereby becoming able to prevent deterioration of damage and noise caused by a collision between the fixed scroll 600 and the orbiting scroll 50, deterioration of compressing efficiency due to leakage in the compression chamber and the backpressure chamber 12d, damage and deterioration of noise and vibration of the first bearing 72, the second bearing 74, the third bearing 76, the eccentric bush, and the drive shaft 30 and the like.

Meanwhile, in the present embodiment, the fixed wrap extension 622 is formed to have a continuous plate shape as illustrated in FIG. 5 so as to continuously and stably support the orbiting wrap entrance end 54a, but is not limited thereto.

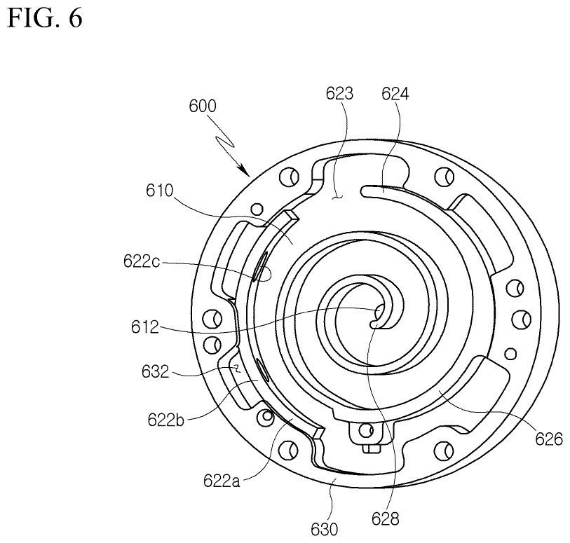

That is, as illustrated in FIG. 6, the fixed wrap extension 622 may include a through hole 622c penetrating the fixed wrap extension 622. In addition, the through hole 622c may be formed in plural number, and the plurality of through holes 622c may be disposed along a circumferential direction of the fixed wrap extension 622. In this case, as the fixed wrap extension 622 supports the orbiting wrap entrance end 54a continuously and stably, the weight and manufacturing cost of the fixed wrap extension 622 can be saved. However, in such a case, because the through hole 622c must be formed through a cutting process after the fixed wrap extension 622 is formed to have a continuous plate shape, the processing cost and the factory overhead may increase.

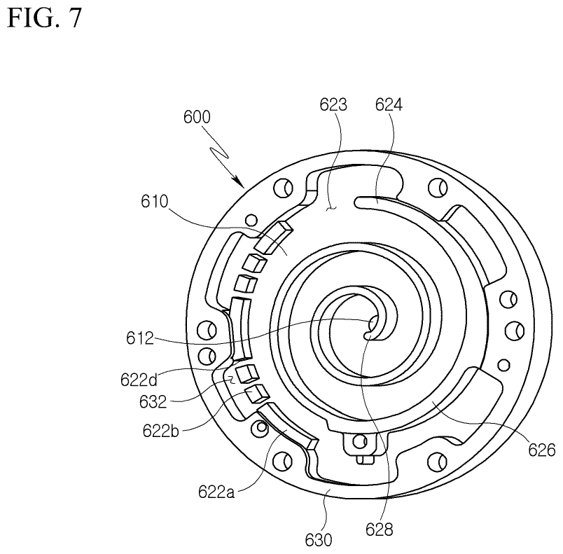

Considering the above fact, as illustrated in FIG. 7, the fixed wrap extension 622 may include a slit 622d formed to be recessed from the distal end surface of the fixed wrap extension 622. In addition, the slit 622d may be formed in plural number, and the plurality of slits 622d may be disposed along a circumferential direction of the fixed wrap extension 622. In this case, it is disadvantageous in the aspect of continuous and stable support of the orbiting wrap entrance end 54a by the fixed wrap extension 622, however, the weight and the manufacturing cost of the fixed wrap extension 622 can be saved as the processing cost and the factory overhead are suppressed, because when a portion for forming the slit 622d is formed in a mold for manufacturing the fixed scroll 600, the fixed wrap extension 622 having the slit 622d can be formed without needing an additional cutting process.

It is apparent that the fixed wrap extension 622 may include both the through hole 622c and the slit 622d.

Meanwhile, when at least one among the through hole 622c and the slit 622d is formed in the non-contacting portion 622b opposing to the recessed portion 632, the refrigerant introduced into the recessed portion 632 may be introduced into the compression chamber through the through hole 622c and the slit 622d as well as into the suction inlet 623, thereby the suction amount of the refrigerant may be increased.

Here, in terms of the shape characteristics of the orbiting wrap 54 and the fixed wrap 620, the refrigerant in the orbiting scroll accommodating space is introduced into the compression chamber mainly through the suction inlet 623, the suction inlet 623 may be preferably formed to be greater than the through hole 622c and the slit 622d.

1-15. (canceled)

16. A scroll compressor comprising:
a drive shaft provided to be rotatable by a drive source;
an orbiting scroll including a disc-shaped orbiting base plate and an orbiting wrap protruding from the orbiting base plate and configured to be orbited by the drive shaft; and
a fixed scroll including a fixed base plate opposing to the orbiting base plate, a fixed wrap protruding from the fixed base plate and engaged with the orbiting wrap, and a fixed wrap extension protruding from the fixed base plate at a position radially spaced apart from the fixed wrap.

17. The scroll compressor of claim 16, wherein the orbiting wrap includes an orbiting wrap entrance end disposed on an outer circumferential portion of the orbiting base plate, and wherein the fixed wrap includes the fixed wrap extension opposing to the orbiting wrap entrance end.

18. The scroll compressor of claim 17, wherein the fixed wrap further comprises a fixed wrap entrance end disposed on an outer circumferential portion of the fixed base plate, a fixed wrap exit end disposed at a center of the fixed base plate, and a fixed wrap spiral extending in a spiral shape from the fixed wrap entrance end to the fixed wrap exit end, and wherein the fixed wrap extension is disposed at a position extended along the spiral shape from the fixed wrap entrance end to an opposite side of the fixed wrap spiral.

19. The scroll compressor of claim 18, wherein an inner circumferential surface of the fixed wrap extension is formed to be contactable with an outer circumferential surface of the orbiting wrap entrance end.

20. The scroll compressor of claim 19, wherein an outer circumferential surface of the fixed wrap extension is formed to have greater roughness than roughness of the inner circumferential surface of the fixed wrap extension.

21. The scroll compressor of claim 18, wherein a distal end surface of the fixed wrap extension is formed to be contactable with the orbiting base plate.

22. The scroll compressor of claim 21, wherein the outer circumferential portion of the orbiting base plate includes a first outer circumferential portion disposed on a side of the orbiting wrap entrance end, and a second outer circumferential portion disposed on an opposite side of the first outer circumferential portion based on a center of the orbiting base plate, and wherein the first outer circumferential portion is contactable with the fixed wrap extension, and the second outer circumferential portion is contactable with at least one among the fixed wrap entrance end and the fixed wrap spiral.

23. The scroll compressor of claim 18, wherein a suction inlet is formed between the fixed wrap entrance end and the fixed wrap extension.

24. The scroll compressor of claim 23, wherein the fixed wrap entrance end and the fixed wrap extension are segmented from each other by the suction inlet.

25. The scroll compressor of claim 23, wherein the fixed wrap extension extends along a spiral shape to the suction inlet.

26. The scroll compressor of claim 18, wherein the fixed scroll further comprises a fixed side wall protruding from the outer circumferential portion of the fixed base plate, and wherein the fixed wrap extension includes a contacting portion in contact with the fixed side wall and a non-contacting portion spaced apart from the fixed side wall.

27. The scroll compressor of claim 26, wherein the fixed side wall includes a recessed portion formed to be recessed on an inner circumferential surface of the fixed side wall at a position opposing to the non-contacting portion.

28. The scroll compressor of claim 27, wherein the fixed wrap extension includes at least one among a through hole penetrating the fixed wrap extension and a slit formed to be recessed from a distal end surface of the fixed wrap extension.

29. The scroll compressor of claim 28, wherein the through hole and the slit are formed in the non-contacting portion.

30. The scroll compressor of claim 29, wherein a suction inlet is formed between the fixed wrap entrance end and the fixed wrap extension, and wherein the suction inlet is formed to be greater than the through hole and the slit.
